(19) United States
(12) Patent Application Publication
(10) Pub. No.: US 2026/0036340 A1
(43) Pub. Date: Feb. 5, 2026

(54) OPTIMIZING FLUID FLOW THROUGH CLOSED-LOOP GEOTHERMAL SYSTEMS

(71) Applicant: Eavor Technologies Inc., Calgary (CA)

(72) Inventors: Christian Besoiu, Calgary (CA); Michael Holmes, Calgary (CA); Matthew Toews, Calgary (CA)

(21) Appl. No.: 19/101,031

(22) PCT Filed: Aug. 5, 2022
(86) PCT No.: PCT/IB2022/057289

§ 371 Date: Feb. 4, 2025

(51) Int. Cl. F24T 10/20; E21B 43/26

(52) U.S. Cl. CPC F24T 10/20; E21B 43/26

(57) ABSTRACT

A method includes causing a first portion of a heat-transfer working fluid to flow from a first lateral wellbore of a closed-loop geothermal well to a second lateral wellbore of the closed-loop geothermal well via a wellbore intersection. The first lateral wellbore and the second lateral wellbore reside in a target subterranean zone. A second portion of the heat-transfer working fluid is caused to flow through the Earth of the target subterranean zone from the first lateral wellbore to the second lateral wellbore.

### TECHNICAL FIELD

This disclosure relates to geothermal systems and methods.

### BACKGROUND

Geothermal systems utilize heat from within the earth for electricity production or for other applications. Some geothermal systems employ a working fluid that is injected into a closed loop of wellbores drilled into the subterranean zone. The working fluid can be recovered after it absorbs heat from the subterranean zone.

### SUMMARY

This disclosure relates to geothermal systems.

Certain aspects of the subject matter herein can be implemented as a method. A heat-transfer working fluid is flowed from a surface inlet of a closed-loop geothermal well through a first lateral wellbore of the closed-loop geothermal well. The first lateral wellbore resides at least partially in a target subterranean zone having a bulk permeability of 10 millidarcies or less. The working fluid is also flowed from a second lateral wellbore of the closed-loop geothermal well to a surface outlet of the closed-loop geothermal well, with the second lateral wellbore residing at least partially in the target subterranean zone and coupled with the first lateral wellbore. A portion of the working fluid flows through the Earth of the target subterranean zone from the first lateral wellbore to the second lateral wellbore by inducing a target pressure differential between the working fluid flowing in the first lateral wellbore and the working fluid flowing in the second lateral wellbore.

An aspect combinable with any of the other aspects can include the following features. Inducing the pressure differential can include inducing the pressure differential with a diametric restriction in the closed-loop geothermal well.

An aspect combinable with any of the other aspects can include the following features. Inducing the target pressure differential can be in part by selecting a working fluid based on a viscosity of the working fluid.

An aspect combinable with any of the other aspects can include the following features. The method can also include positioning the first lateral wellbore and second lateral wellbores relative to one another based in part on the bulk permeability of the target subterranean zone.

An aspect combinable with any of the other aspects can include the following features. A portion of the Earth of the target subterranean zone can include porous rock, and flowing of the portion of the working fluid through the Earth of the target subterranean zone from the first lateral wellbore to the second lateral wellbore can include flowing the portion of the working fluid through pores of the porous rock.

An aspect combinable with any of the other aspects can include the following features. A portion of the Earth of the target subterranean zone can include rock within which are fractures. Flowing of the portion of the working fluid through the Earth of the target subterranean zone from the first lateral wellbore to the second lateral wellbore can include flowing the portion of the working fluid through the fractures.

An aspect combinable with any of the other aspects can include the following features. A portion of the Earth of the target subterranean zone can include rock within which are thermal fractures induced by a difference between an inherent temperature of the Earth of the target subterranean zone and a temperature of a cooler fluid flowed from the surface inlet through the first lateral wellbore or the second lateral wellbore. Flowing of the portion of the working fluid through the Earth of the target subterranean zone from the first lateral wellbore to the second lateral wellbore can include flowing the portion of the working fluid through the thermal fractures.

An aspect combinable with any of the other aspects can include the following features. The cooler fluid can be the working fluid.

An aspect combinable with any of the other aspects can include the following features. The cooler fluid can be the drilling fluid.

An aspect combinable with any of the other aspects can include the following features. Inducing of the thermal fractures can include expanding existing thermal or natural fractures.

An aspect combinable with any of the other aspects can include the following features. The Earth of the target subterranean zone between the first lateral wellbore and the second lateral wellbore can be not fractured by a hydraulic fracturing treatment.

An aspect combinable with any of the other aspects can include the following features. The second lateral wellbore can be coupled with the first lateral wellbore at a wellbore intersection.

An aspect combinable with any of the other aspects can include the following features. The portion of the working fluid flowing through the Earth of the target subterranean zone from the first lateral wellbore to the second lateral wellbore can be a first portion of the working fluid, and the method can further include flowing a second portion of the working fluid from the first lateral wellbore to the second lateral wellbore through the wellbore intersection.

An aspect combinable with any of the other aspects can include the following features. The bulk permeability of the target subterranean zone between the first lateral wellbore and the second lateral wellbore can be a bulk permeability prior to the flowing of working fluid through the closed-loop geothermal well.

An aspect combinable with any of the other aspects can include the following features. The average inherent temperature of the Earth of the target subterranean zone between the first lateral wellbore and the second lateral wellbore, can be, prior to the flowing of the working fluid through the closed-loop geothermal well, greater than 80 degrees Celsius.

An aspect combinable with any of the other aspects can include the following features. The average inherent temperature of the Earth of the target subterranean zone between the first lateral wellbore and the second lateral wellbore can be, prior to the flowing of the working fluid through the closed-loop geothermal well, greater than 120 degrees Celsius.

An aspect combinable with any of the other aspects can include the following features. Inducing the pressure differential between the working fluid flowing in the first lateral wellbore and the working fluid flowing in the second lateral wellbore can include increasing the pressure differential from a baseline pressure differential between the working fluid flowing in the first lateral wellbore and the working fluid flowing in the second lateral wellbore prior to the inducement.

An aspect combinable with any of the other aspects can include the following features. Flowing the working fluid from the second lateral wellbore of the closed-loop geothermal well to the surface outlet can be via a thermosiphon.

An aspect combinable with any of the other aspects can include the following features. The working fluid can have a coefficient of thermal expansion of greater than 10⁻¹K⁻¹.

Certain aspects of the subject matter herein can be implemented as a system that includes a closed-loop geothermal well including a first lateral wellbore and a second lateral wellbore both residing at least partially within a target subterranean zone having a bulk permeability of 10 millidarcies or less. The system further includes a heat-transfer working fluid. The system is configured to flow the working fluid from a surface inlet of the closed-loop geothermal well through the first lateral wellbore and thence through the second lateral wellbore to a surface outlet of the closed-loop geothermal well, and to flow at least a portion of the working fluid through the Earth of the target subterranean zone from the first lateral wellbore to the second lateral wellbore by inducing a target pressure differential between the working fluid flowing in the first lateral wellbore and the working fluid flowing in the second lateral wellbore.

An aspect combinable with any of the other aspects can include the following features. The system can also include a diametric restriction in the closed-loop geothermal well and configured to at least in part induce the pressure differential.

An aspect combinable with any of the other aspects can include the following features. A portion of the Earth of the target subterranean zone can include porous rock, and the system can be configured to flow at least a portion of the working fluid through the Earth of the target subterranean zone from the first lateral wellbore to the second lateral wellbore through pores of the porous rock.

An aspect combinable with any of the other aspects can include the following features. A portion of the Earth of the target subterranean zone can include rock within which are fractures, and the system can be configured to flow at least a portion of the working fluid through the Earth of the target subterranean zone from the first lateral wellbore to the second lateral wellbore through the fractures.

An aspect combinable with any of the other aspects can include the following features. A portion of the Earth of the target subterranean zone comprises rock within which are thermal fractures induced by a difference between an inherent temperature of the Earth of the target subterranean zone and a temperature of a cooler fluid flowed from the surface inlet through the first lateral wellbore or the second lateral wellbore, and wherein the system is configured to flow at least a portion of the working fluid through the Earth of the target subterranean zone from the first lateral wellbore to the second lateral wellbore through the thermal fractures.

An aspect combinable with any of the other aspects can include the following features. The second lateral wellbore can be coupled with the first lateral wellbore at a wellbore intersection.

An aspect combinable with any of the other aspects can include the following features. The portion of the working fluid flowing through the Earth of the target subterranean zone from the first lateral wellbore to the second lateral wellbore can be a first portion of the working fluid, and wherein the system is further configured to flow a second portion of the working fluid from the first lateral wellbore to the second lateral wellbore through the wellbore intersection.

Certain aspects of the subject matter herein can be implemented as a method including causing a first portion of a heat-transfer working fluid to flow from a first lateral wellbore of a closed-loop geothermal well to a second lateral wellbore of the closed-loop geothermal well via a wellbore intersection (with the first lateral wellbore and the second lateral wellbore residing in a target subterranean zone) and causing a second portion of the heat-transfer working fluid to flow through the Earth of the target subterranean zone from the first lateral wellbore to the second lateral wellbore.

An aspect combinable with any of the other aspects can include the following features. Causing the second portion of the heat-transfer working fluid to flow through the Earth of the target subterranean zone from the first lateral wellbore to the second lateral wellbore can be by inducing a target pressure differential between the working fluid flowing in the first lateral wellbore and the working fluid flowing in the second lateral wellbore.

An aspect combinable with any of the other aspects can include the following features. The pressure differential can be induced at least in part by a diametric restriction in the first lateral wellbore.

An aspect combinable with any of the other aspects can include the following features. The target subterranean zone can have a bulk permeability of 10 millidarcies or less.

### BRIEF DESCRIPTION OF DRAWINGS

FIG. 1 is schematic illustration of a closed-loop geothermal system in accordance with the concepts herein.

FIG. 2 is a schematic illustration of an inlet lateral wellbore and outlet lateral wellbore pair in a target subterranean zone, in accordance with the concepts herein.

FIG. 3 is a process flow diagram of a method in accordance with the concepts herein.

### DETAILED DESCRIPTION

In closed-loop geothermal systems, a working fluid is circulated within a closed loop including a subsurface well and a surface or subsurface facility that is configured to extract the heat for use. In certain instances, the facility includes a heat exchanger for extracting the heat and conveying it into a related process such as a Rankine cycle (e.g., Organic Rankine Cycle) or other heat cycle that generates electricity, a steam generation process for industrial, agricultural or residential use, or another process. In certain instances, the facility directly uses the heated working fluid, such as by passing it through an expander (e.g., a turbine) that drives an electric generator or directly using the heat of the working fluid in an industrial, agricultural, or residential process. In such a closed-loop system, contact between the working fluid and the natural fluids (for example, groundwater) of the subterranean zone is substantially eliminated or minimized by the piping, wellbore casing, wellbore sealants, and other components or features of the system.

According to the concepts herein, in certain instances, the closed-loop systems can include one or more inlet surface wellbores and one or more outlet surface wellbores drilled into a target subterranean zone. In certain instances, one or more inlet lateral wellbores extend from a downhole end of a surface inlet wellbore and one or more outlet lateral wellbores extend from a downhole end of an outlet surface wellbore. In certain instances, the lateral wellbore(s) can comprise a network of multilateral wellbores, and can be horizontal, sloped acutely or obtusely relative to vertical, or otherwise non-vertical. In certain instances, the inlet lateral wellbore(s) intersect or otherwise fluidically couple with the outlet lateral wellbore(s), for example, by intersecting at their respective downhole ends. In certain instances, some or all of the working fluid flowed through the closed-loop system flows through such intersections.

According to the concepts herein, in certain instances, flowing some or all of the working fluid through the Earth of the subterranean zone, rather than through the intersections or other drilled couplings of the wellbore(s), can increase the productivity and efficiency of the closed-loop system.

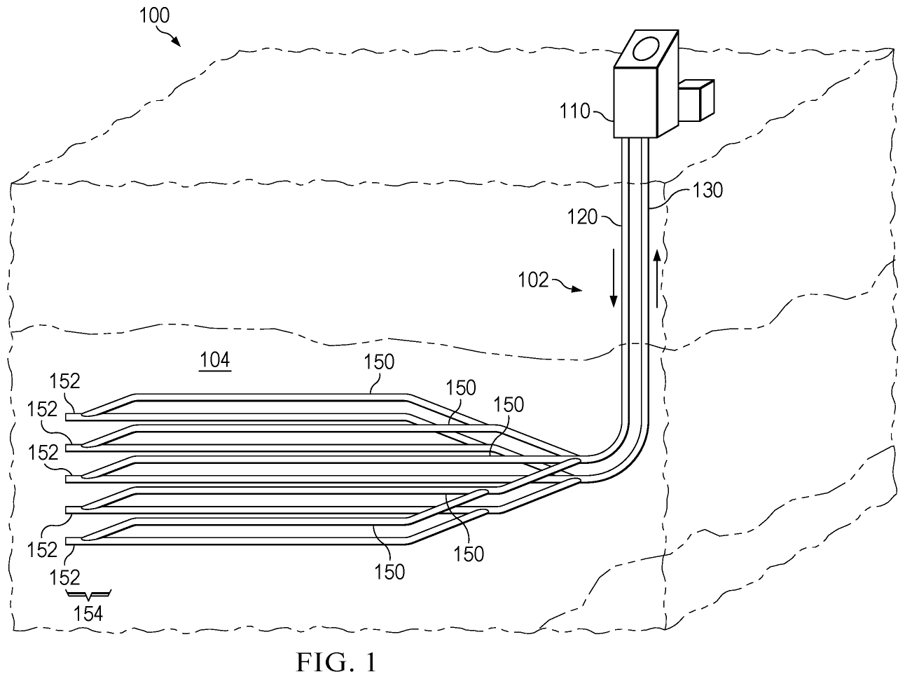

FIG. 1 shows a closed-loop geothermal system in accordance with the concepts herein. In certain instances, the closed-loop geothermal wellbore system can be, for example, a system such as that developed by Eavor Technologies Inc. of Calgary, Alberta, which includes a network of sealed lateral wellbores which exchange heat with the subterranean zone.

Referring to FIG. 1, system 100 includes a closed loop system having a well 102 drilled into a target subterranean zone 104. In the illustrated instance, well 102 includes an inlet surface wellbore 120 and an outlet surface wellbore 130 in close proximity, each extending between the terranean surface and target subterranean zone 104. Inlet surface wellbore 120 splits into a plurality of inlet lateral wellbores 150 and outlet surface wellbore likewise splits into a plurality of outlet lateral wellbores 152. In other instances, the inlet surface wellbore 120 and the outlet surface wellbore can be separated by a longer distance, with the lateral wellbores connecting them in the subsurface, forming a U-shape configuration. Target subterranean zone 104 can comprise all or part of a geological formation or all or part of multiple geological formations, and can comprise rock or other geological materials.

In the illustrated instance, inlet surface wellbore 120 and outlet surface wellbore 130 are vertical wellbores, drilled substantially straight (i.e., without the use of directional drilling methods or equipment). The lateral wellbores 150 and 152 can be drilled substantially horizontal, for example, by using directional drilling methods and equipment, and include a curve in their trajectory beginning at a kickoff from vertical. In other instances, the inlet and/or outlet surface wellbores are other than vertical and/or may be drilled with the use of directional drilling. In some instances, some or all of the lateral wellbores are other than horizontal. In some (not all) instances, the lateral wellbores 150 and/or 152 are drilled so as to follow the geological dip of the formation in the subterranean zone. In some instances, lateral wellbores 150 and/or 152 can be anywhere from 2000 meters to 8000 meters or more in length and/or from 1000 meters to 8000 meters in depth from the surface. In some instances, lateral wellbores 150 and/or 152 can be greater than 8000 meters in length and/or depth.

In some instances, inlet lateral wellbores 150 and outlet lateral wellbores 152 are coupled. For example, in the illustrated instance, inlet lateral wellbores 150 and outlet lateral wellbores are coupled by intersecting with each other, forming wellbore intersections 154 at their respective toes. A wellbore intersection includes an intersection where the drilled diameter of a first wellbore intersects with the drilled diameter of a second wellbore. In other instances, in addition to or instead of being coupled by intersecting with each other, the lateral wellbores can be coupled by each intersecting with a cavity (such as an enlarged cavity intentionally formed by drilling or a cavity formed by the complete or partial collapse of the rock face surrounding a first wellbore proximate to a second wellbore such that a cavity is formed connecting the wellbores), or by each intersecting with a third wellbore.

A heat-transfer working fluid can be added to the well and can be flowed from inlet surface wellbore 120 into inlet lateral wellbores 150. In the illustrated instance, at least a portion of the working fluid flows from inlet lateral wellbores 150 through intersections 154 to outlet lateral wellbores 152, and thence to outlet surface wellbore 130. In the illustrated instance, system 100 further includes a facility 110 disposed between inlet surface wellbore 120 and outlet surface wellbore 130. In certain instances, facility 110 includes a heat exchanger for extracting the heat from the working fluid received from outlet surface wellbore 130 and conveying it into a related process, such as a Rankine cycle (e.g., Organic Rankine Cycle) or other heat cycle that generates electricity, a steam generation process for industrial, agricultural, or residential use, or another process. In certain instances, instead of or in addition to a heat exchanger, facility 110 directly uses the heated working fluid, such as by passing it through an expander (e.g., a turbine) that drives an electric generator or directly using the heat of the working fluid in an industrial, agricultural, or residential process. In some instances, facility 110 is disposed at or near the Earth's surface; in other instances, facility 110 may be disposed partially or fully within a subsurface location. From facility 110, after at least a portion of the heat is extracted, the working fluid can be flowed back into inlet surface wellbore 120, in a closed-loop.

In some implementations, valves, packers, and other flow control equipment can be used in the well to selectively open or close or otherwise control working fluid flow through the surface inlet wellbores or the lateral wellbores. In some implementations, the working fluid can be circulated in the well using a surface pump until circulation is self-sustaining. For example, in some instances, the well can be configured to generate a thermosiphon effect driven by the density difference in the working fluid between the inlet surface wellbore and the outlet surface wellbore such that the working fluid flows to the surface when heated in the subterranean zone, without the use of a pump. In some instances, artificial lift from pump can be used to provide a supplemental increase to the flow of the working fluid above that provided by the thermosiphon effect. Suitable pumps can include, for example, a submersible downhole pump or a surface pump. Artificial lift can also be induced by flowing in a portion of the well a second working fluid of a different density than the working fluid flowing in the remaining portion of the well. For example, in some instances, a second working fluid can be flowed in a portion of the well via a concentric tubing string.

In some instances, the working fluid can be a fluid with a non-linear temperature enthalpy relationship to maximize the temperature differential and heat transfer between the fluid and target subterranean zone 104. In some instances, the working fluid can be an aqueous electrolyte solution as described in U.S. Pat. App. Pub. No. 20190346181. In some instances, working fluid can be water-based. In some instances, working fluid can have a high heat capacity (i.e., greater than 3.0 kJ/kg-K and/or a high coefficient of thermal expansion (i.e., greater than 10⁻⁴ K⁻¹)). In addition to its heat transfer properties, the working fluid can be environmentally benign, non-toxic, stable at high temperatures and pressures, capable of flow, and able to provide compressive strength to the subsurface formation.

In some instances, a majority of the lengths of inlet surface wellbore 120 and outlet surface wellbore 130 are cased, and lateral wellbores 150 and 152 are open hole. In some instances, the entire length of lateral wellbores 150 and 152 can be open hole; in other instances, lateral wellbores can be open hole at the couplings where lateral wellbores 150 and 152 meet inlet surface wellbore 120 and outlet surface wellbore 130 (for example, at the intersections 154) and lined for at least a portion of the distance between those couplings (for example, lined in those portions where the subterranean zone is susceptible to collapse due to faulting and/or unconsolidated geological materials, but otherwise open hole).

In some instances, some or all of the lengths of lateral wellbores 150 and 152 can be substantially sealed without the use of casing by forming an interface between the lateral wellbore and the subterranean zone substantially impermeable to fluids. Such sealing may be done by various methods. For example, in some instances, a drilling fluid can be used during drilling operations that precipitates into a solid upon contact with rock, creating a substantially impermeable seal. In some instances, in addition to or instead of depositing sealant material, the drilling fluid may cause damage to the rock surrounding the wellbore, decreasing the rock's permeability. Some such methods are described in U.S. Pat. App. Pub. No. US20200011151A1. In some instances, slugs of fluids with sealant can be added to the drilling fluid while drilling or to the working fluid. In some instances, instead of or in addition to sealing during drilling operations, lateral wellbores 150 and 152 can be sealed by including a sealant in the working fluid. In some instances, lateral wellbores 150 and 152 can be periodically re-sealed (or sealing enhanced) by performing periodic treatments with sealant.

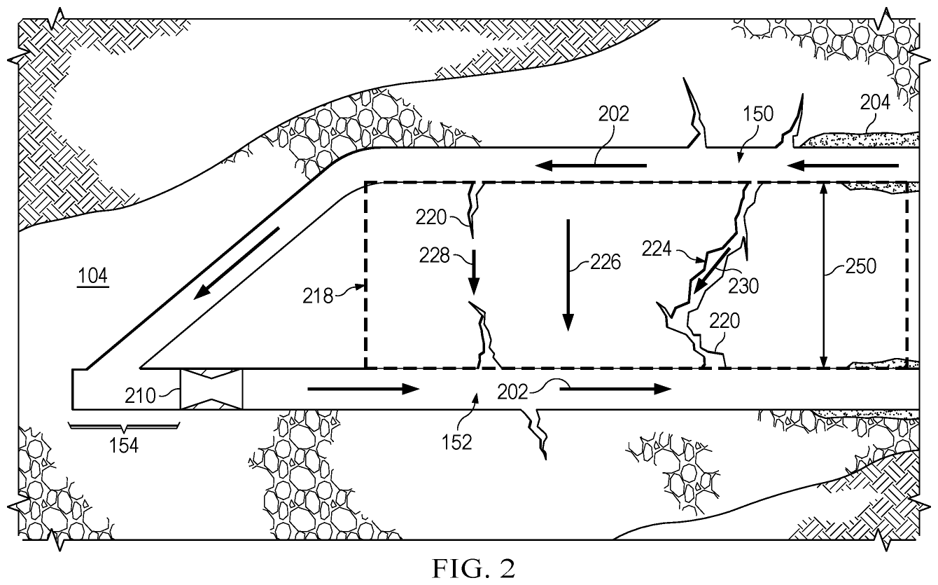

FIG. 2 is a more detailed schematic illustration of a pair of lateral wellbores within a target subterranean zone in accordance with the concepts herein. Referring to FIG. 2, and as also described in reference to FIG. 1, inlet lateral wellbore 150 and outlet lateral wellbore 152 reside within target subterranean zone 104 and intersect at intersection 154. Working fluid 202 flows through inlet lateral wellbore 150 and through intersection 154 and thence through outlet wellbore 152.

Reducing or eliminating loss of working fluid from the system and reducing or minimizing dilution of the working fluid by natural formation fluids can increase the efficiency and effectiveness of closed-loop well system. In the illustrated instance, a sealant 204 at least partially seals at least a portion of the length of lateral wellbores 150 and 152, and such sealant can in some instances reduce or substantially eliminate flow of the working fluid 202 from the lateral wellbores 150 and 152 into target subterranean zone 104, and also reduce or substantially eliminate flow of natural formation fluid (if any) into lateral wellbores 150 and 152. Likewise, in some instances, target subterranean zone 104 may be comprised of Earth having no or substantially no porosity and/or permeability, which can likewise inhibit or prevent (or further inhibit or prevent) such fluid flow. If lateral wellbores 150 and 152 are sealed or substantially sealed, and/or if target subterranean zone 104 has little or no permeability, then substantially all of volume of the working fluid 202 flowing from inlet lateral wellbores 150 to outlet lateral wellbores is through intersection 154.

In some instances it can be advantageous or desirable for at least a portion (or, in some instances, all or substantially all) of the working fluid to flow from inlet lateral wellbores 150 to outlet lateral wellbores 152 through the porous rock or other geological materials of the Earth of target subterranean zone 104 between inlet lateral wellbores 150 and outlet lateral wellbores 152 (i.e., not through intersections 154 but instead through, for example, some or all of Earth portion 218 and/or the other portions of the Earth of subterranean zone 104 between the lateral wellbores). Such flow through the Earth of the subterranean zone (rather than through the wellbore intersection 154 or other drilled couplings) can increase the contact area or contact time between the working fluid and the high-temperature rock of the target subterranean zone and/or displace (or sweep out) the natural formation fluid, thereby increasing the heat extraction and productivity of the closed-loop geothermal system. In some instances, target subterranean zone 104 has at least some (but relatively low) porosity and permeability. In such instances, all or sufficient portion of that volume of working fluid 202 flowed through the Earth can be recovered by outlet lateral wellbore 152, with the amount of working fluid loss and the amount of mixing or dilution by natural formation fluid both sufficiently small to retain the closed-loop character of the system. For example, in some instances, target subterranean zone 104 has a bulk permeability of greater than 0.01 millidarcies but equal to or less than 10 millidarcies (prior to the flowing of working fluid through the closed-loop geothermal well). In some instances, target subterranean zone 104 is not a viable subterranean zone from which to produce commercial amounts of oil, gas, or water.

Flow of fluid through a porous medium such as a porous rock formation is governed by Darcy's law, which can be expressed as:

$$Q = \frac{k A}{μ L} Δ P$$

In the above equation, Q is the flow rate of the fluid, A is the cross-sectional area of the fluid in contact with the formation, L is the length the fluid must travel through the formation, μ is fluid viscosity, k is permeability, and ΔP is the pressure differential along length L. Accordingly, a flow of working fluid from the inlet lateral wellbores to the outlet lateral wellbores through a porous rock of the Earth of the subterranean zone can be induced or increased by, for example, inducing a pressure differential between the working fluid flowing in the inlet lateral wellbores and the working fluid flowing in the outlet lateral wellbores. For example, inducing such a pressure differential can comprise increasing the pressure differential from a baseline pressure differential, i.e., a pressure differential that exists prior to the inducement, between the working fluid flowing in the first lateral wellbore and the working fluid flowing in the second lateral wellbore. Alternatively or in addition, the flow can be increased by selecting a working fluid with a relatively low viscosity (or decreasing the viscosity of the working fluid), increasing the cross-sectional area in contact with the formation, and/or decreasing the length the fluid must travel across the formation.

As mentioned above, flow of working fluid through the wellbores of some closed-loop geothermal systems can be driven by a natural thermosiphon effect propagated by the density difference in the working fluid between the inlet surface wellbore and the outlet surface wellbore, reducing or eliminating the need for a circulating pump for normal operation. Also as mentioned above, in some instances a pump can provide artificial lift to supplement the thermosiphon effect. In some instances, the pressure of the working fluid in the outlet well can be larger than the required pressure to overcome hydraulic losses at optimal working fluid flow rates. Rather than bleeding off this excess pressure at surface (for example, via a control valve), one or more diametric restrictions—such as diametric restriction 210 of FIG. 2—can be installed in one or more of the lateral wellbores to increase the pressure differential between the working fluid flowing in the inlet lateral wellbores and the working fluid flowing in the outlet lateral wellbores. In the instance shown in FIG. 2, diametric restriction 210 is installed in outlet lateral wellbore 152, proximate intersection 154. Diametric restriction 210 can in some instances include a reduced-diameter orifice, an orifice with flexible or inflexible baffles or fingers, an adjustable control valve, or other fixed or adjustable restriction. The size, shape, and other characteristics of diametric restriction 210 can be selected to result in a desired pressure differential. A narrower restriction in the inlet wellbore can result in a greater pressure differential than a wider restriction. For example, for a wellbore with a diameter of 0.216 meters, a pressure drop from 45 MPa to 44 MPa (for a pressure differential of 1000 kPa) can be achieved with a circular orifice plate with an orifice diameter of 0.0156 meters, a mass flowrate of 5 kg/s, a discharge coefficient of 0.6, and a working fluid density of 950 kg/m³.

In some instances, the rate of flow of working fluid from the inlet lateral wellbores to the outlet lateral wellbores through the Earth of the subterranean zone can be increased by selecting a working fluid having a lower viscosity or by reducing the viscosity of the working fluid. For example, in some instances, a viscosity-reducing chemical additive can be added to the working fluid. Such viscosity-reduction can have a further advantage by reducing the pump load requirement of the system (if one or more external pumps are used).

In some instances, while the Earth of the target subterranean zone between the first lateral wellbore and the second lateral wellbore target subterranean zone 104 may have fractures or fissures, it is not fractured by a hydraulic fracturing job. For example, in some instances, a cooled radial profile can develop in the area surrounding the wellbore as heat is extracted from the subterranean zone through conduction. In some instances, this cooled profile is most considerable in the inlet lateral wellbore, where the working fluid temperature is coolest, and where there is a higher driving force of heat extraction from the rock (driven by the difference in temperature between the rock and fluid). As the surrounding rock cools, depending on the structural and thermal properties of the formation, minor near wellbore fractures/fissures—such as fractures 220 of FIG. 2—can develop. This phenomenon (which is distinct from fracturing from a hydraulic fracturing job) can reduce the resistance to flow of working fluid from the inlet lateral wellbores to the outlet lateral wellbores through the Earth of the subterranean zone and/or decreasing the distance that the fluid flows through the porous media, leading to increased heat extraction without the need for hydraulic fracturing or other methods of artificial permeability enhancement. In some instances, such induced fractures can intersect natural fractures (such as fractures 224) already present in the Earth of the target subterranean zone prior to drilling of wellbores 150 and 152. In some instances, all (or substantially all) of the flow of working fluid 202 through the Earth from wellbore 150 to wellbore 152 (i.e., that portion not flowing through the intersections 154) follows a flowpath (such as flowpath 226 through Earth portion 218) through the pores of the porous rock and therefore all (or substantially all) of such flow follows Darcy's law (i.e., can be described by the Darcy equation). In some instances (for example, flowpath 228 through Earth portion 218), a portion of the flowpath of the working fluid 202 through the Earth from wellbore 150 to wellbore 152 is through the porous rock (and therefore follows Darcy's law) and a portion is through natural or induced fractures. In some instances (for example, flowpath 230 through Earth portion 218), all or substantially all of the flowpath of the working fluid 202 through the Earth from wellbore 150 to wellbore 152 is through natural or induced fractures.

In some instances, flow of working fluid from the inlet lateral wellbores to the outlet lateral wellbores through the Earth of the subterranean zone can be increased by drilling the lateral wellbores such that the distance 250 between inlet lateral wellbore(s) 150 and outlet lateral wellbore(s) 152 is relatively small. For example, in some instances, the distance 250 can be a distance of between 30 meters and 100 meters. In other instances, the distance 250 can be a greater or lesser distance. In some instances, flow of working fluid from the inlet lateral wellbores to the outlet lateral wellbores through the Earth of the subterranean zone can be increased by drilling lateral wellbores of a greater diameter, thus increasing the surface area of the fluid in contact with the subterranean zone.

In some instances, the design, construction, and operation of the closed-loop system can be chosen or modified based in part on the permeability, fluid saturation, and/or other characteristics of the subterranean zone, as estimated or determined based on (for example) rock samples from the wellbores of the well, in-situ measurements taken during or after drilling of the initial or subsequent wellbore (or wellbores), or samples or measurements from other wells constructed in or near the subterranean zone.

Table 1 below shows various hypothetical parameters for different designs for a closed-loop well that is constructed in a subterranean zone, using simplified examples in which the total flow rate is held constant. In some designs a diametric restriction is installed as shown in FIG. 2 that is designed (as described above) to increase the pressure differential between the lateral wellbores and thereby cause at least a portion of the working fluid to flow through the Earth from the inlet lateral wellbores to the outlet lateral wellbores (in addition to flowing through the intersections of the wellbores). Case 1 considers a closed-loop well of the type shown in FIGS. 1 and 2 but that includes no diametric restriction. Case 2 considers a similar closed-loop well design as in Case 1 but that also includes a diametric restriction installed in the lateral wellbores as shown in FIG. 2. Case 3 considers similar closed-loop well design as in Case 2 but that also includes a surface pump and also a downhole submersible pump to increase the working fluid flow rate. Case 4 considers a similar closed-loop well design as in Case 2 but that also includes artificial lift induced via introduction of a lower-density fluid within a portion of the wellbores.

TABLE 1

| Parameter | Case 1 | Case 2 | Case 3 | Case 4 |
|---|---|---|---|---|
| Total thermosiphon pressure (kPa) | +2000 | +2000 | +2000 | +4000 |
| Surface pump pressure gain (kPa) | 0 | 0 | +1000 | 0 |
| Submersible downhole pump | 0 | 0 | +1000 | 0 |
| pressure gain (kPa) | | | | |
| Wellbore hydraulic losses (kPa) | −1000 | −1000 | −1000 | −1000 |
| Pressure drop at surface via | −1000 | 0 | 0 | 0 |
| control valve (kPa) | | | | |
| Pressure drop across diametric | 0 | −1000 | −3000 | −3000 |
| restriction (kPa) | | | | |
| Net System Pressure Change (kPa) | 0 | 0 | 0 | 0 |
| Flow through wellbores (kg/s) | 60 | 50 | 30 | 30 |
| Flow through Earth (kg/s) | 0 | 10 | 30 | 30 |
| Total Flow (kg/s) | 60 | 60 | 60 | 60 |

For purposes of Table 1, the Net System Pressure Change can be defined as: (Thermosiphon Pressure+Surface Pump Pressure Gain+Downhole Submersible Pump Pressure Gain) minus (Wellbore Hydraulic Losses+Pressure Drop and Surface+Pressure Drop Across the Diametric Restriction). In each case shown in Table 1, the Net System Pressure change is held at zero and the total flow through the system is 60 kilograms per second (kg/s). In Case 2, the inclusion of the diametric restriction supports a portion of the total flow (10 kg/s) flowing through the Earth with the remainder through the wellbore intersections. In Case 3, the design supports a larger portion of the total flow (30 kg/s) flowing through the Earth with the remainder through the wellbore intersections. In Case 4, the design likewise supports 30 kg/s flowing through the Earth with the remainder through the wellbore intersections.

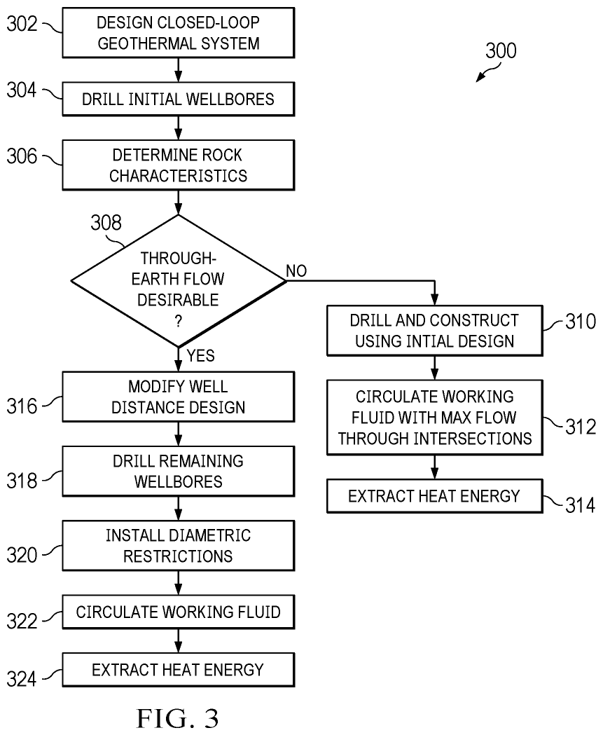

FIG. 3 is a process diagram of a method of designing, constructing, and operating a closed-loop geothermal system in accordance with an instance of the present disclosure. The method starts at step 302, in which a closed-loop geothermal well system is initially designed on the assumption (based in turn on assumed or tentative determinations of permeability or other characteristics of the target subterranean zone) that heat production and efficiency will be maximized by completely sealing the lateral wellbores against any flow of fluid to or from the subterranean zone (such that all or substantially all of the working fluid flows from the inlet lateral wellbores to the outlet lateral wellbores via the wellbore intersections). At step 304, one or more initial wellbores are drilled. At step 306, the porosity, permeability, and natural fluid saturation of the target subterranean zone is further characterized (such as by analyzing rock samples or performing in-situ measurements with suitable downhole measurement tools). At step 308, it can be determined, based on the further characterization, whether heat production and efficiency can be maximized by inducing or increasing the flow of at least a portion of the working fluid through the Earth of the target subterranean zone (in addition to or instead of through the intersections) from the first lateral wellbore to the second lateral wellbore. If at step 308 the determination is negative (i.e. the initial design assumptions are validated based on the subterranean zone characterization), the method proceeds to steps 310 through 314 in which the remaining wellbores are drilled and the remainder of the system constructed (310), the working fluid circulated (312), and the heat energy extracted from the system (314) (for example, with a heat exchanger) and used for power generation or other applications, in accordance with the original designs.

If at step 308 the determination is positive (i.e., it is determined based on the permeability (and other determined characterizations) of the subterranean zone that heat production and efficiency can be maximized by inducing or increasing the flow of at least a portion of the working fluid through the Earth of the target subterranean zone (in addition to or instead of through the intersections)), then the method proceeds to step 316 in which the design of the planned system is modified relative to the initial design (by, for example, increasing or decreasing the planned distance between the inlet lateral wellbores and the outlet lateral wellbores). At step 318, the remaining wellbores are drilled in accordance with the modified design. At step 320, one or more diametric restrictions (such as diametric restrictions 210 of FIG. 2) are installed in one or more of the lateral wellbores to increase the pressure differential between the working fluid flowing in the inlet lateral wellbores and the outlet lateral wellbores. In some instances, as described above, other modifications or additions to the well system can be added or included so as to increase the pressure differential, instead of or in addition to diametric restrictions. In some instances, some or all of the sealant (if any) already applied to all or a portion of the lateral wellbores is removed, so as to further enable the flow of the working fluid through the Earth between the lateral wellbores. At step 322, a working fluid (for example, a low viscosity working fluid) is circulated. Also at step 322 (or at another suitable time), a drag reducing agent can be added to the working fluid. At step 324, heat energy is extracted from the system in accordance with the modified design.

In certain instances, all of some of steps 316, 318, 320, 322 and 324 are performed in response to the positive determination in step 308. In other instances, only one, or only some, of steps 316, 318, 320, 322 and 324 are performed in response to the positive determination in step 308. In certain instances, some or all of steps 316, 318, 320, 322 and 324 are performed in a different order than as described above. In certain instances, additional or alternative steps are performed (instead of or in addition to) steps 316, 318, 320, 322 and/or 324 to enhance or increase the flow of working fluid through the Earth between the lateral wellbores, and/or to otherwise complete, optimize, and operate the geothermal well system.

While this disclosure contains many specific implementation details, these should not be construed as limitations on the subject matter or on what may be claimed, but rather as descriptions of features that may be specific to particular implementations. Certain features that are described in this disclosure in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Nevertheless, it will be understood that various modifications, substitutions, and alterations may be made. While operations are depicted in the drawings or claims in a particular order, this should not be understood as requiring that such operations be performed in the particular order shown or in sequential order, or that all illustrated operations be performed (some operations may be considered optional), to achieve desirable results. Accordingly, the previously described example implementations do not define or constrain this disclosure.

1. A method, comprising:
flowing a heat-transfer working fluid from a surface inlet of a closed-loop geothermal well through a first lateral wellbore of the closed-loop geothermal well, the first lateral wellbore residing at least partially in a target subterranean zone having a bulk permeability of 10 millidarcies or less;
flowing the working fluid from a second lateral wellbore of the closed-loop geothermal well to a surface outlet of the closed-loop geothermal well, the second lateral wellbore residing at least partially in the target subterranean zone and coupled with the first lateral wellbore;
causing a portion of the working fluid to flow through the Earth of the target subterranean zone from the first lateral wellbore to the second lateral wellbore by inducing a target pressure differential between the working fluid flowing in the first lateral wellbore and the working fluid flowing in the second lateral wellbore.

2. The method of claim 1, wherein inducing the pressure differential comprises inducing the pressure differential with a diametric restriction in the closed-loop geothermal well.

3. The method of claim 1, comprising inducing the target pressure differential in part by selecting a working fluid based on a viscosity of the working fluid.

4. (canceled)

5. (canceled)

6. (canceled)

7. (canceled)

8. (canceled)

9. (canceled)

10. (canceled)

11. The method of claim 1, wherein the Earth of the target subterranean zone between the first lateral wellbore and the second lateral wellbore is not fractured by a hydraulic fracturing treatment.

12. The method of claim 1, wherein the second lateral wellbore is coupled with the first lateral wellbore at a wellbore intersection.

13. The method of claim 12, wherein the portion of the working fluid flowing through the Earth of the target subterranean zone from the first lateral wellbore to the second lateral wellbore is a first portion of the working fluid, and wherein the method further comprises flowing a second portion of the working fluid from the first lateral wellbore to the second lateral wellbore through the wellbore intersection.

14. The method of claim 1, wherein the bulk permeability of the target subterranean zone between the first lateral wellbore and the second lateral wellbore is a bulk permeability prior to the flowing of working fluid through the closed-loop geothermal well.

15. The method of claim 1, wherein the average inherent temperature of the Earth of the target subterranean zone between the first lateral wellbore and the second lateral wellbore, is, prior to the flowing of the working fluid through the closed-loop geothermal well, greater than 80 degrees Celsius.

16. The method of claim 1, wherein the average inherent temperature of the Earth of the target subterranean zone between the first lateral wellbore and the second lateral wellbore, is, prior to the flowing of the working fluid through the closed-loop geothermal well, greater than 120 degrees Celsius.

17. The method of claim 1, wherein inducing the pressure differential between the working fluid flowing in the first lateral wellbore and the working fluid flowing in the second lateral wellbore comprises increasing the pressure differential from a baseline pressure differential between the working fluid flowing in the first lateral wellbore and the working fluid flowing in the second lateral wellbore prior to the inducement.

18. The method of claim 1, wherein the flowing the working fluid from the second lateral wellbore of the closed-loop geothermal well to the surface outlet is via a thermosiphon.

19. The method of claim 1, wherein the working fluid has a coefficient of thermal expansion of greater than 10⁻⁴K⁻¹.

20. A system comprising:
a closed-loop geothermal well comprising a first lateral wellbore and a second lateral wellbore both residing at least partially within a target subterranean zone having a bulk permeability of 10 millidarcies or less; and
a heat-transfer working fluid, wherein the system is configured to:
flow the working fluid from a surface inlet of the closed-loop geothermal well through the first lateral wellbore and thence through the second lateral wellbore to a surface outlet of the closed-loop geothermal well; and
flow at least a portion of the working fluid through the Earth of the target subterranean zone from the first lateral wellbore to the second lateral wellbore by inducing a target pressure differential between the working fluid flowing in the first lateral wellbore and the working fluid flowing in the second lateral wellbore.

21. The system of claim 20, further comprising a diametric restriction in the closed-loop geothermal well and configured to at least in part induce the pressure differential.

22. The system of claim 20, wherein a portion of the Earth of the target subterranean zone comprises porous rock, and wherein the system is configured to flow at least a portion of the working fluid through the Earth of the target subterranean zone from the first lateral wellbore to the second lateral wellbore through pores of the porous rock.

23. The system of claim 20, wherein a portion of the Earth of the target subterranean zone comprises rock within which are fractures, and wherein the system is configured to flow at least a portion of the working fluid through the Earth of the target subterranean zone from the first lateral wellbore to the second lateral wellbore through the fractures.

24. The system of claim 20, wherein a portion of the Earth of the target subterranean zone comprises rock within which are thermal fractures induced by a difference between an inherent temperature of the Earth of the target subterranean zone and a temperature of a cooler fluid flowed from the surface inlet through the first lateral wellbore or the second lateral wellbore, and wherein the system is configured to flow at least a portion of the working fluid through the Earth of the target subterranean zone from the first lateral wellbore to the second lateral wellbore through the thermal fractures.

25. (canceled)

26. (canceled)

27. A method comprising:
causing a first portion of a heat-transfer working fluid to flow from a first lateral wellbore of a closed-loop geothermal well to a second lateral wellbore of the closed-loop geothermal well via a wellbore intersection, the first lateral wellbore and the second lateral wellbore residing in a target subterranean zone; and
causing a second portion of the heat-transfer working fluid to flow through the Earth of the target subterranean zone from the first lateral wellbore to the second lateral wellbore.

28. The method of claim 27, wherein causing the second portion of the heat-transfer working fluid to flow through the Earth of the target subterranean zone from the first lateral wellbore to the second lateral wellbore is by inducing a target pressure differential between the working fluid flowing in the first lateral wellbore and the working fluid flowing in the second lateral wellbore.

29. The method of claim 27, wherein the pressure differential is induced at least in part by a diametric restriction in the first lateral wellbore.

30. (canceled)
